(19) United States
(12) Patent Application Publication
(10) Pub. No.: US 2023/0135849 A1
(43) Pub. Date: May 4, 2023

(54) SYSTEM AND METHOD FOR PROVIDING ELECTRIC VEHICLE LOCATION ASSESSMENTS

(71) Applicant: Volta Charging, LLC, San Francisco, CA (US)

(72) Inventors: Haroon Ali Akbar, Montreal (CA); David J. Klein, Los Altos, CA (US); Anna Bailey, San Francisco, CA (US); Brian Bowen, San Francisco, CA (US); Silas M. Toms, San Francisco, CA (US)

(21) Appl. No.: 17/932,970

(22) Filed: Sep. 16, 2022

Related U.S. Application Data
(63) Continuation of application No. 17/891,885, filed on Aug. 19, 2022.
(60) Provisional application No. 63/235,226, filed on Aug. 20, 2021.

(51) Int. Cl. G06Q 30/0601; G06F 18/2113; G06F 18/20

(52) U.S. Cl. CPC G06Q 30/0623; G06F 18/2113; G06F 18/295

(57) ABSTRACT

An approach is provided for generating an electric vehicle score (EVScore), a rating scale representing, for a user, a future estimated ease of ownership and operation of an EV within a defined geographic region. The method includes receiving a plurality of regional engine inputs pertaining to a defined geographic region, and one or more user inputs pertaining to the user. The method also includes processing, via a predictive model, the plurality of regional engine inputs and the one or more user inputs to generate one or more intermediate scores for the defined geographic region. The method also includes receiving a plurality of projected inputs pertaining to projected ownership and operation costs and benefits of electric vehicles (EVs) for the defined geographic region. The method also includes processing, via a trained machine learning model, the plurality of projected inputs and the one or more intermediate scores to generate the EVS core.

### BENEFIT CLAIM

This application claims the benefit under 35 U.S.C. § 120 as a continuation of application 17/891,885 filed Aug. 19, 2022, which claims the benefit of provisional application 63/235,226, filed Aug. 20, 2021, by Haroon Ali Akbar et al., the entire contents of which is hereby incorporated by reference as if fully set forth herein, under 35 U.S.C. § 119(e).

### FILED OF THE INVENTION

The present invention relates to providing electric vehicle location assessments and in particular, for generating assessments for particular locations or areas based on demographic, availability, cost, awareness, and policy data associated with those locations.

### BACKGROUND

Spurred by a multitude of factors, electric vehicle (EV) adoption is increasing at an historically unprecedented pace. More than ever before, individuals and companies are interested in exploring what it would be like to own an EV in a particular geographic location. Currently, potential EV owners have limited information to determine and thus can attempt to make an “educated guess” as to how convenient (or inconvenient) it would be to own an EV at a given location, such as where they currently live or where they plan to move. However, if the assessment made is inaccurate, they may find themselves with a relatively expensive car that is inconvenient to charge. Poor access to EV charging availability information may also produce a situation where owners shy away from EVs, limiting electric vehicle adoption because more polluting vehicles continue to be used and further contribute to pollution problems, even though, with the right information in hand, EV ownership that is less polluting would have been highly desirable and convenient to many consumers. To avoid these problems, it is desirable to provide automated, data-driven techniques to accurately evaluate, measure and/or express how easy it is to own and maintain an EV in a particular geographic region.

### BRIEF DESCRIPTION OF THE DRAWINGS

In the drawings:

FIG. 1 is a diagram presenting an overview of data flows through components of an Electric Vehicle Score Engine (EVScore Engine) to generate an electric vehicle score (EVScore), according to an embodiment.

FIG. 2 is a diagram presenting example data inputs and outputs for components of the EVScore Engine, according to an embodiment.

FIG. 3 is a diagram presenting an example EVScore generation using the EVScore Engine, according to an embodiment.

FIG. 4 is a flow diagram that illustrates steps to generate an EVScore, according to an embodiment.

FIG. 5 is a block diagram of a computer system upon which the techniques described herein may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

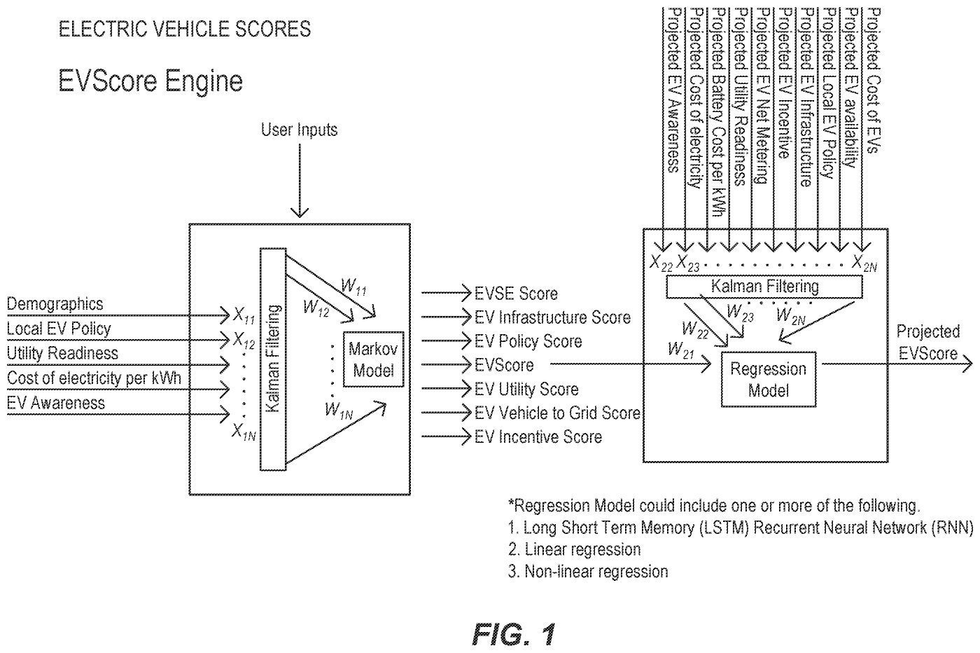

FIG. 1 is a diagram presenting an overview of data flows through components of an Electric Vehicle Score Engine (EVScore Engine) to generate an electric vehicle score (EVScore), according to an embodiment. The EVScore that is generated by the EVScore engine for a specific geographic area indicates how easy it is to own, lease or use (collectively referred to as “own” and “ownership”) and maintain an EV in that specific geographic area. Ownership may include full outright ownership and various partial ownership or installment plans including car sharing, rental, and lease agreements. A higher score, e.g. a score of 95 out of 100, indicates that is it easy or attractive to own and maintain an EV in the specific geographic area for which the score was generated. A lower score, e.g. a score of 25 out of 100, indicates that it is less easy/attractive to have an EV in the specific geographic area for which the score was generated. In some implementations, the reverse may be true, wherein a lower EVScore indicates greater attractiveness for owning and maintaining an EV, and a higher EVScore indicates less attractiveness for owning and maintaining an EV. Further, the EVScore may also be expressed in various formats, such as a 1 to 5-star rating representation. An intermediate EVScore may be generated to reflect past and current EV ownership conditions, whereas a projected EVScore may be generated to further integrate projected EV ownership conditions in the future, as estimated by a trained machine learning algorithm. The EVScore may be a weighted combined score of several intermediate scores, as discussed in further detail below.

### Projected Score Generation: Stage 1

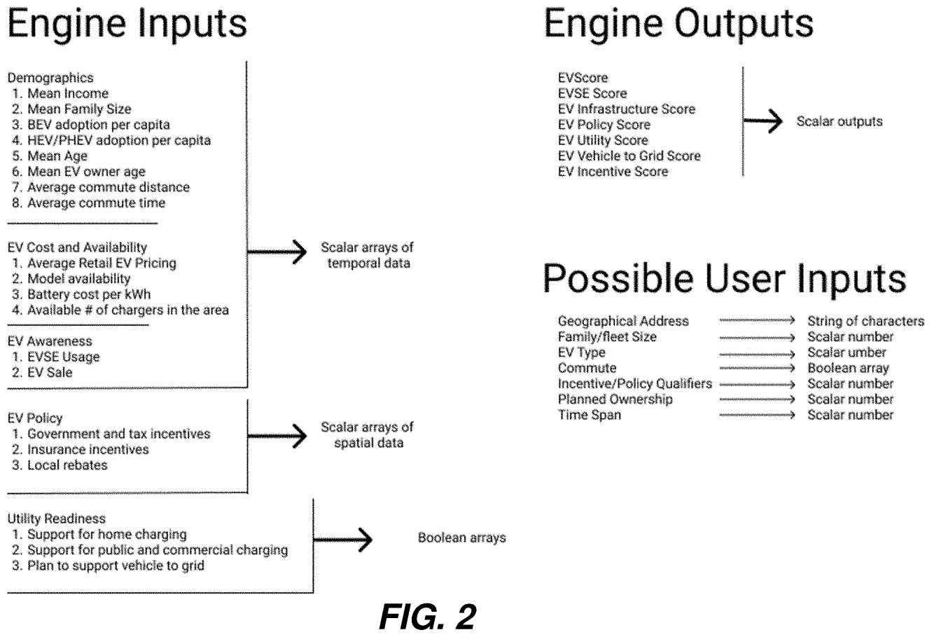

In a first stage of projected score generation, depicted by the left grey block in FIG. 1, a number of different scores may be generated. Various engine inputs such as demographics, Local EV policy, etc. are provided as input to a Kalman filter which fill gaps in input data and/or mitigates any noise in the data. Any applicable Kalman filtering techniques may be used. In addition to the engine inputs, the EVScore engine may also accept user inputs such as geographical address, EV Type, Commute, etc. Examples of engine inputs and possible user inputs are shown below with their corresponding data types in FIG. 2, a diagram presenting example data inputs and outputs for components of the EVScore Engine, according to an embodiment. As shown in FIG. 2, the engine inputs may include temporal data, e.g. of previously recorded data samples, or spatial data, e.g. for subregions within the specific geographic area, or Boolean values.

Once the user inputs and engine inputs are processed by Kalman filtering techniques, weights are applied to each input value. The weights may be defined by a system administrator. The weighted input values are provided as input to a Markov Model which combines the weighted inputs into a single score. Any applicable Markov Modeling techniques may be used.

Examples of possible intermediate scores that are generated during stage 1 include:
EVSE Score (for the availability and quality of EV supply equipment/charging stations),
EV Infrastructure Score (for the availability of EV infrastructure to support EVSE),
EV Policy Score (for the availability of government and other regulatory policies encouraging EV adoption),
EV Score (an intermediate EVScore used as a basis to calculate a projected EVScore),
EV Utility Score (for the readiness of utility providers and electrical grids for supporting EV infrastructure),
EV Vehicle to Grid Score (for the availability of vehicle to grid programs for pushing power back to utility grids from EV batteries),
EV incentive Score (for the availability of public and private incentives for EV adoption).

In some embodiments, the type of intermediate score that is generated is based on the weights that are applied to the filtered input values. For example, an “EV Policy Score” may indicate that a higher weight was applied to a “Local EV Policy” input value, as opposed to an “EV Infrastructure Score” which indicates that a higher weight was applied to a “Available # of chargers in the area” input value. Further, in some embodiments, the EVScore may be a combined weighted score of various intermediate scores, which may be selected from the example intermediate scores listed above.

### Projected Score Generation: Stage 2

In a second stage of projected score generation, depicted by the right grey block in FIG. 1, a projected EVScore is generated using a combination of Kalman filtering and machine learning techniques.

Various projected inputs including one or more of:
projected Cost of EVs (e.g., whether EVs are projected to increase or decrease in purchase price in the future),
projected EV availability (e.g., whether stock of a desired EV brand/model/make is projected to be easily available or limited in future supply chains),
projected local EV policy (e.g., whether future EV policy is projected to be more favorable or less favorable to EV adoption),
projected EV infrastructure (e.g., whether EV infrastructure is projected to be more built or less built in the future),
projected EV incentive (e.g., whether EV incentives are projected to increase or decrease in the future),
projected EV net metering (e.g., whether utility net metering policies are projected to become favorable or unfavorable to EV adopters in the future),
projected utility Readiness (e.g., whether utilities are projected to be ready or less ready for EV adoption in the future),
projected battery cost per kWh (e.g., whether the cost of EV batteries for a given capacity are projected to become more expensive or less expensive in the future),
projected Cost of electricity (e.g., whether the cost of charging an EV is projected to become more expensive or less expensive in the future),
projected EV awareness (e.g., whether EV awareness is projected to increase or decrease in the future),
   are provided as input to a Kalman filter which fill gaps in input data and/or mitigates any noise in the data. Any applicable Kalman filtering techniques may be used. The projected inputs are projected or calculated using any applicable techniques or insight. Once the user inputs and engine inputs are processed by Kalman filtering techniques, weights are applied to each projected value. The weights may be defined by a system administrator.

The weighted projected values, along with one or more of the intermediate score values that were generated by the first stage, are provided as inputs to a trained machine learning model, such as a regression model shown in FIG. 1. Based on the inputs, the trained machine learning model provides a projected score as output. In the example shown in FIG. 1, the projected score is an EVScore, and the intermediate EVScore from the left gray block is used as an input into the regression model. As discussed above, the intermediate EVScore may correspond to a weighted combination of various intermediate scores. In some implementations, other projected scores besides the projected EVScore may also be determined by using any of the other intermediate scores as inputs into the regression model, either singly or in any combination. Training and configuration of the machine learning model is discussed in the section titled “MACHINE LEARNING ENGINE”. In some embodiments, the type of projected score that is generated is based on the type of intermediate score that is provided as input into the regression model, as shown in FIG. 1. For example, a “Projected EV Policy Score” may be generated on the basis of using an “EV Policy Score” as input into the regression model.

### Machine Learning Engine

In one embodiment, the regression model shown in FIG. 1 is trained using a training dataset. The regression model may comprise any of: Long Short Term memory (LSTM), recurrent neural network (RNN), Linear Regression, and Non-linear regression.

The training dataset may include labeled ground truth values that correspond to combinations of inputs of the regression model. Labeled ground truth values are established to train the regression model of EVScore Engine. Each ground truth value comprises a value of 0-100 for various geographical addresses. The 0-100 values may be collected by a combination of the following sources: 1) consensus of experts from the following fields: a. Urban planning and design b. Statistics and Stochastics c. Anthropology d. Architecture e. Demography. 2) Mapping to proxy levels including the following: a. Real-estate valuation b. EV sales c. EVSE Usage d. Number of dealerships selling EVs. 3) Experience quantified by ratings including the following. a. Local PlugScore (by PlugShare) ratings b. Parking lots with EVSE ratings on Google or Apple Maps.

It is crucial to note that the EVScore Engine does not crucially depend on any one of the aforementioned sources or factors of ground truth. If a source or factor is to be removed, the EVScore engine can be reconfigured.

### Applications Of Electric Vehicle Scores

Once an EVScore is generated, there are many different applications of the score.

In one embodiment, a geographical address is used as user input to the EVScore engine to generate an EVScore. The EVScore may indicate: whether a real estate property of interest has sufficient EV infrastructure, how friendly to EVs the real estate property of interest is, how friendly a real estate portfolio that includes the real estate property of interest is.

In another embodiment, a geographical address, a time span, and incentive/policy qualifies are used as user input to the EVScore engine to generate EV ownership trends, a geographic representation of EVScores, and one or more incentive/policy recommendations. Such generated values provide an overview and a detailed analysis of EV adoption in a respective jurisdiction and help understand EV adoption rends in a geographic region.

In another embodiment, a geographical address, family/fleet size, incentive/policy qualifiers, and commute distance are used as user input to the EVScore engine to generate an EVScore and EV recommendations. Such generated values help understand how easy it is to transition a non-EV fleet of vehicle to an EV fleet, and whether a neighborhood/real estate property of interest has sufficient EV infrastructure.

In another embodiment, a geographical address, time span, incentive/policy qualifiers, and current market valuation are used as user input to the EVScore engine to generate a projected EVScore and project portfolio valuation based on historical trends. Such generated values help understand how EV adoption will affect real estate portfolio valuation.

In another embodiment, a representation of a generated EVScore or EVScores is displayed in conjunction with a particular location or a plurality of locations. For example, a map of a city may illustrate different EVScores for each block, zip code, or selected region. Different colorings of geographic areas may be used to indicate a higher or lower score for each geographic area.

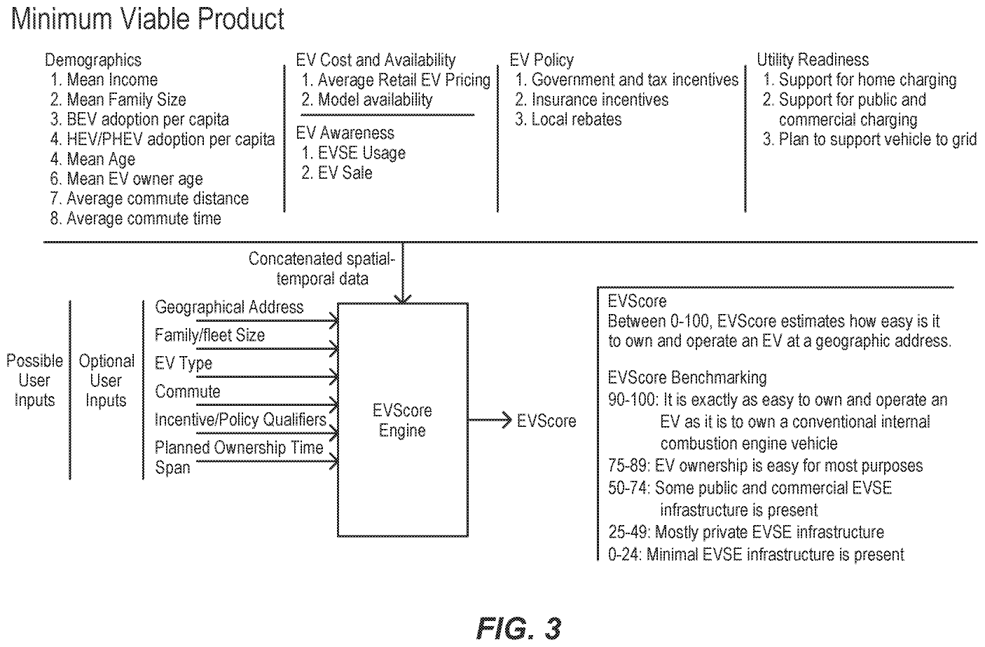

FIG. 3 is a diagram presenting an example EVScore generation using the EVScore Engine of FIG. 1, according to an embodiment. As shown in FIG. 3, possible user inputs include: geographical address, family/fleet size, EV type, commute, incentive/policy qualifiers, planned ownership time span. Optional user inputs include a subset of the possible user inputs such as: family/fleet size, EV type, commute, incentive/policy qualifiers, planned ownership time span. Optional and possible user inputs are not limited to the inputs shown in this example. Engine inputs include: demographic values such as mean income, mean family size, Battery Electric Vehicle (BEV) adoption per capita, HEV/PHEC adoption per capita, mean age, mean EV owner age, average commute distance, average commute time, EV cost and availability values such as average retail EV pricing, model availability, EV awareness values such as EVSE usage, EV sales, EV policy values such as government and tax incentives, insurance incentives, local rebates, and utility readiness values such a support for home charging, support for public and commercial charging, plans to support vehicle to grid programs.

As shown in FIG. 3, An EVScore comprises a value from 0-100 and indicates how easy it is to own and operate an EV at a geographical address. In one embodiment, an EVscore from 90-100 indicates that it is exactly as easy to own and operate an EVscore as it is to own a conventional internal combustion engine vehicle. A EVscore from 75-89 indicates that EV ownership is easy for most purposes. An EVscore from 50-74 indicates that some public and commercial EVSE infrastructure is present. An EVscore from 25-49 indicates that mostly private EVSE infrastructure exists. An EVscore of 0-24 indicates that minimal EVSE infrastructure is present.

### Implementation Processes

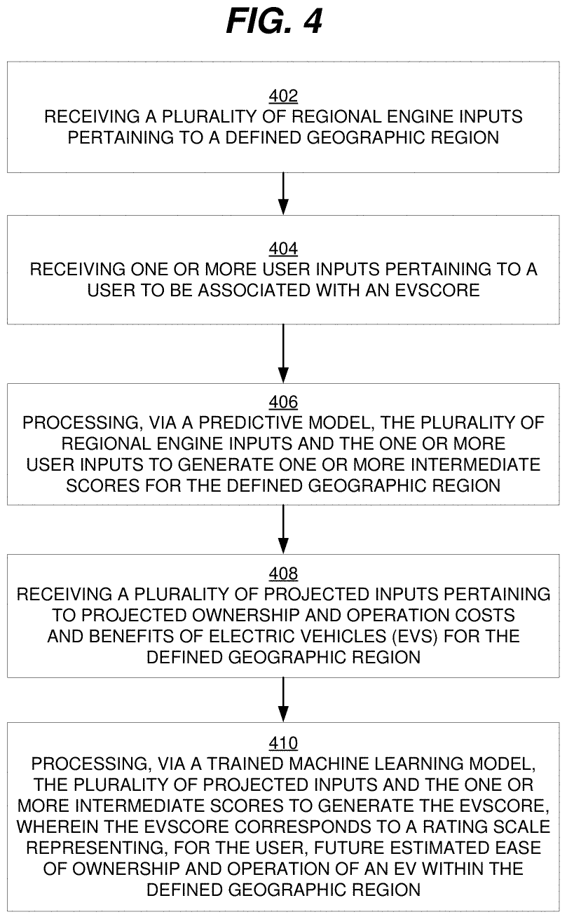

FIG. 4 is a flow diagram 400 that illustrates steps to generate an EVScore, according to an embodiment.

In block 402, referring to FIG. 1, the EVScore Engine receives, at the left grey block, a plurality of regional engine inputs pertaining to a defined geographic region. In the example shown in FIG. 1, the regional engine inputs include demographics, local EV policy, utility readiness, cost of electricity per kWh, and EV awareness. However, other inputs may also be included, as shown in e.g. FIG. 2. While not specifically shown, the defined geographic region may be provided by a user by, for example, selecting a region from a displayed map, or entering a ZIP code, county, city, state, or other geographic indicator.

In block 404, referring to FIG. 1, the EVScore Engine receives, at the left grey block, one or more user inputs pertaining to a user to be associated with the EVScore. Example user inputs are illustrated in FIG. 2, as discussed above.

In block 406, referring to FIG. 1, the EVScore Engine processes, via a predictive model at the left grey block, the plurality of regional engine inputs from block 402 and the one or more user inputs from block 404 to generate one or more intermediate scores for the defined geographic region. As shown in FIG. 1, the predictive model may correspond to a Markov Model, but other predictive models may also be utilized. Further, the inputs to the predictive model may be filtered (e.g. by Kalman filtering) and weighted prior to processing in block 406. In the example shown in FIG. 1, the EVScore Engine generates an intermediate EVScore. However, other possible intermediate scores include an EV supply equipment score (EVSE Score), an EV infrastructure score, an EV policy score, an EV utility score, an EV vehicle to grid score, and an EV incentive score. Further, as discussed above, the intermediate EVScore may also correspond to a weighted combination of one or more of these intermediate scores.

In block 408, referring to FIG. 1, the EVScore Engine receives, at the right grey block, a plurality of projected inputs pertaining to projected ownership and operation costs and benefits of electric vehicles (EVs) for the defined geographic region. As shown in FIG. 1, the projected inputs may include projected Cost of EVs, projected EV availability, projected local EV policy, projected EV infrastructure, projected EV incentive, projected EV net metering, projected utility Readiness, projected battery cost per kWh, projected Cost of electricity, and projected EV awareness. However, other combinations of projected inputs may also be input in block 408.

In block 410, referring to FIG. 1, the EVScore Engine processes, via a trained machine learning model at the right grey block, the plurality of projected inputs from block 408 and the one or more intermediate scores from block 406 to generate the EVScore, wherein the EVScore corresponds to a rating scale representing, for the user, future estimated ease of ownership and operation of an EV within the defined geographic region. The trained machine learning model may be based on a regression model, as discussed above. The EVScore may be provided on a scale from 0-100, as described further in FIG. 3. Further, in various implementations, the EVScore may include other inputs and considerations not explicitly shown in the above examples.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

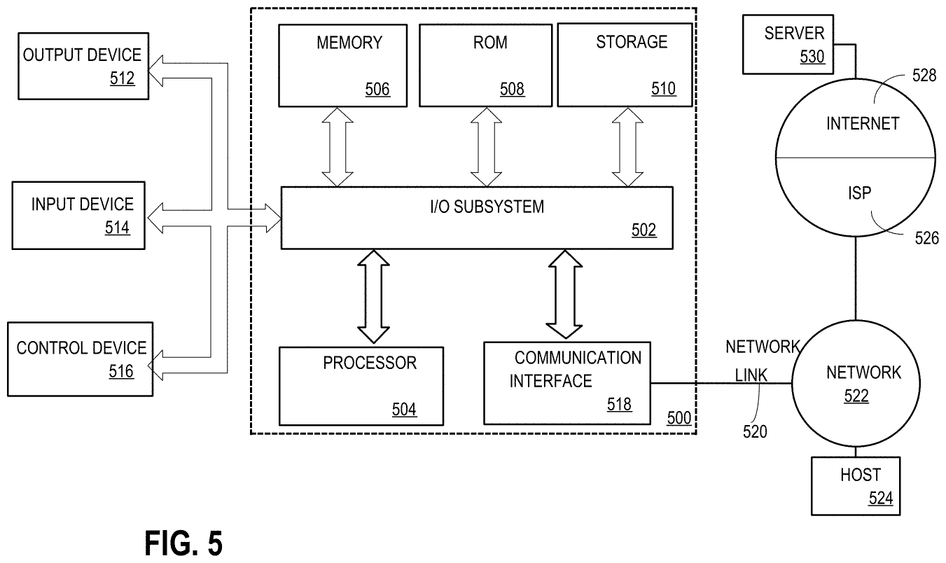

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method for generating an electric vehicle score (EVScore), the method comprising:
receiving a plurality of regional engine inputs pertaining to a defined geographic region;
receiving one or more user inputs pertaining to a user to be associated with the EVScore;
processing, via a predictive model, the plurality of regional engine inputs and the one or more user inputs to generate one or more intermediate scores for the defined geographic region;
receiving a plurality of projected inputs pertaining to projected ownership and operation costs and benefits of electric vehicles (EVs) for the defined geographic region; and
processing, via a trained machine learning model, the plurality of projected inputs and the one or more intermediate scores to generate the EVScore, wherein the EVScore corresponds to a rating scale representing, for the user, future estimated ease of ownership and operation of an EV within the defined geographic region.

2. The method of claim 1, wherein prior to processing via the predictive model, the plurality of regional engine inputs and the one or more user inputs are processed through a Kalman filter and are weighted.

3. The method of claim 1, wherein prior to processing via the trained machine learning model, the plurality of projected inputs is processed through a Kalman filter and is weighted, and the one or more intermediate scores are weighted.

4. The method of claim 1, wherein the predictive model is a Markov model.

5. The method of claim 1, wherein the trained machine learning model is a regression model.

6. The method of claim 5, wherein the regression model is selected from one of: Long Short Term memory (LSTM), recurrent neural network (RNN), Linear Regression, or Non-linear regression.

7. The method of claim 1, wherein the plurality of regional engine inputs includes at least one of:
demographic data;
EV cost and availability;
EV awareness;
EV policies and incentives; or
utility readiness.

8. The method of claim 1, wherein the plurality of regional engine inputs includes at least one of: temporal data of previously recorded data samples, or spatial data for subregions within the defined geographic region.

9. The method of claim 1, wherein the one or more user inputs includes at least one of:
a home location within the defined geographic region;
a family size;
a vehicle fleet size;
a desired EV type;
a commute distance;
personal qualification for EV incentives or policies;
a planned quantity of EVs to be owned; or
a planned ownership time span.

10. The method of claim 1, wherein the one or more intermediate scores include at least one of:
an intermediate EVScore;
an EV supply equipment score (EVSE Score);
an EV infrastructure score;
an EV policy score;
an EV utility score;
an EV vehicle to grid score; or
an EV incentive score.

11. A non-transitory computer readable medium comprising instructions executable by a processor to:
receive a plurality of regional engine inputs pertaining to a defined geographic region;
receive one or more user inputs pertaining to a user to be associated with an EVScore;
process, via a predictive model, the plurality of regional engine inputs and the one or more user inputs to generate one or more intermediate scores for the defined geographic region;
receive a plurality of projected inputs pertaining to projected ownership and operation costs and benefits of electric vehicles (EVs) for the defined geographic region; and
process, via a trained machine learning model, the plurality of projected inputs and the one or more intermediate scores to generate the EVScore, wherein the EVScore corresponds to a rating scale representing, for the user, future estimated ease of ownership and operation of an EV within the defined geographic region.

12. The non-transitory computer readable medium of claim 11, wherein prior to processing via the predictive model, the plurality of regional engine inputs and the one or more user inputs are processed through a Kalman filter and are weighted.

13. The non-transitory computer readable medium of claim 11, wherein prior to processing via the trained machine learning model, the plurality of projected inputs is processed through a Kalman filter and is weighted, and the one or more intermediate scores are weighted.

14. The non-transitory computer readable medium of claim 11, wherein the predictive model is a Markov model.

15. The non-transitory computer readable medium of claim 11, wherein the trained machine learning model is a regression model.

16. The non-transitory computer readable medium of claim 15, wherein the regression model is selected from one of: Long Short Term memory (LSTM), recurrent neural network (RNN), Linear Regression, or Non-linear regression.

17. The non-transitory computer readable medium of claim 11, wherein the plurality of regional engine inputs includes at least one of:
demographic data;
EV cost and availability;
EV awareness;
EV policies and incentives; or
utility readiness.

18. The non-transitory computer readable medium of claim 11, wherein the plurality of regional engine inputs includes at least one of: temporal data of previously recorded data samples, or spatial data for subregions within the defined geographic region.

19. The non-transitory computer readable medium of claim 11, wherein the one or more user inputs includes at least one of:
a home location within the defined geographic region;
a family size;
a vehicle fleet size;
a desired EV type;
a commute distance;
personal qualification for EV incentives or policies;
a planned quantity of EVs to be owned; or
a planned ownership time span.

20. The non-transitory computer readable medium of claim 11, wherein the one or more intermediate scores include at least one of:
an intermediate EVScore;
an EV supply equipment score (EVSE Score);
an EV infrastructure score;
an EV policy score;
an EV utility score;
an EV vehicle to grid score; or
an EV incentive score.
